(19) United States
(12) Patent Application Publication
(10) Pub. No.: US 2017/0159698 A1
(43) Pub. Date: Jun. 8, 2017

(54) OVAL SPRING LOCKING RING

(71) Applicant: Robert A. Locker, Bozeman, MT (US)

(72) Inventor: Robert A. Locker, Bozeman, MT (US)

(21) Appl. No.: 14/961,976

(22) Filed: Dec. 8, 2015

(51) Int. Cl. F16B 45/02

(52) U.S. Cl. CPC F16B 45/02

(57) ABSTRACT

An oval spring tension ring with left and right hooks at the opening on the top mid-section. This can contain one or more items or provide a connection between two points. Entry is achieved by slipping items over the hooks. Locking and unlocking is provided by squeezing inward on the outside of the end portions of the oval. The right and left hooks slide by one another and, upon release of the pressure, engage the hooks locking the ring securely.

### FIELD OF THE INVENTION

An oval locking ring for securing multiple objects in a spring tension ring or connecting two opposite points or functions

### BACKGROUND OF THE INVENTION

There are several billion containing or connecting rings in use around the world and are predominantly of the ‘split ring’ design. They are used to contain/connect many different types and sizes of objects such as keys, pet tags, hooks to fishing lures etc., and are one of the most needed and useful devices in both the modern and developing countries.

However, they are often difficult to use and lack the strength to perform the holding functions for which they were designed.

Here is an illustration with which most of you will relate:

You have a key ring right? But, it still has your mother's house key on it, which she sold over two years ago. And you made a spare key for your wife's car over a year ago, but it is still in the top dresser drawer in the bedroom. Why? Because it is a hassle to pry the keys off your key ring and add others.

What if you could remove and replace those keys on a secure ring in “two seconds”, using only your fingertips? With the Oval Spring Locking Ring, those two seconds become literal. 1 will explain how a little bit later.

Also, there are several areas of potential use that are simply not practical or available in the standard split ring design. Jewelry is one such area, as most women have many sets of ear rings, cocktail rings, and necklaces that could be placed on a locking ring that is easy to open and close securely. Often these items take up several drawers or an entire dresser. It would be far better and more convenient if these similar items could be housed together on one ring. Trying to separate a dozen necklaces that are piled on top of one another, is not the most efficient way to “dislodge” your choice for the evening.

As mentioned, the most commonly used for connection and containment is the “split ring”. The principal is relatively simple. An object or objects are inserted at one end of the ring and slid around (the ring) to the terminal point which then allows the object(s) to be contained on the ring itself. It has been altered from the “slide on and around” concept including a variety which has one end that extends into the middle of the split ring, ostensibly for ease of entry.

There is also a ring which is hinged in the middle and snaps together at the terminal ends. However, it has no real strength at the connection point which often results in the objects spilled and scattered accidentally.

The split ring is often used with small objects (such as fishing lures) to attach the lure to the line and hooks to various parts of the lure itself. This usually requires the use of a tool called a split ring pliers to open the ring sufficiently to allow objects to be started and then maneuvered around the ring until the object reaches the other end. This is time consuming and requires a great deal of dexterity to perform causing more labor in assembling the attachments to the lure and results in higher cost to the consumer.

There are several types of lures which develop their “action” from the vibration created as the lure wobbles from side to side. Almost all plugs (such as the Rapala, Rebel, Rattletrap to name a few well known trademarks) develop maximum action with a split ring or other means where the line is secured to the lure. A loop knot can accomplish this, but the majority of anglers do not have the needed knot tying skills. If a heavy line is tied with the standard more familiar knots like the “improved clinch knot”, the action and vibration is diminished.

These plug style lures are best used without a swivel, as fish are wary of unnecessary connection devices where the lure attaches to the line. This brings me to yet another shortfall in the fishing industry.

This is called “terminal tackle”, a major segment of the industry. Most snaps do not have the capacity to open on both ends. That means that snap/swivels are connected at the factory and there is no ability for the angler to fit the correct size snap to the proper swivel. Also the current snaps are elongate and more bulky than necessary. Although anglers could attach a swivel to a split ring it is seldom, if ever, done because of the difficulty of opening the split ring to allow the swivel to be threaded onto the ring.

This will all change with the introduction of the Oval Spring Locking Ring.

The fishing line industry has gone through a revolution in the past few years with the advent of braided lines. They have little or no stretch and are often preferred over monofilament lines which have a large degree of give and do not let the angler detect small details, such as the action of the lure or contact with the bottom. They do, however, provide a stretch component that can keep the line from breaking with the impact of a strike or the fighting efforts of the fish.

The major braided lines (“Fireline” by Berkeley, “Power-Pro” by Honeywell, and “Spiderwire” in the Spectra family) are very popular but have one major drawback. Due to the lack of stretch, they often break below their rated strength, when encountering a hard “strike” or abrupt snag.

The Oval Spring Locking Ring, has a built in “shock absorber” and will flatten somewhat on sudden impact giving these braided lines just enough play to prevent quick stress line breakage. When the Oval Spring Locking Ring is available, I believe the braided line manufacturers will recommend the use of this device in their marketing literature because it eliminates their biggest shortcoming.

In medium sized common applications, such as containing pet tags and keys, the processes is difficult because the end user does not normally have a split ring pliers available as would be the case in a manufacturing assembly situation. This often results in the use of whatever is handy, such as a knife. This is dangerous and results in many minor injuries. When attempted without any tool, the end result is often damaged or broken finger nails.

Also the split ring often does not have sufficient strength to keep the tags or keys contained and the ring is sometimes pulled apart resulting in the loss of valuable tags or keys. There is no resistance point to the ring itself and when made of a fine diameter wire, it is easier to feed the tag or key onto the ring but increases the risk of loss. When heavier gauge and strength wire is used, the attachment process is made more difficult and ads to the risk of injury as noted above.

In larger applications which would have substantial use, such as containing a set of sockets or kitchen utensils of various sizes, the current products simply are too cumbersome and difficult to slide sets of objects onto a ring.

The “clip together” ring is relatively easy to thread on items, but there is little connective strength to these devices and often results in the objects being dropped and scattered, defeating the purpose. Assembly of commonly used products of different sizes is a huge problem.

Here is another illustration.

Most people who maintain their properties or do repairs and projects own a set or two of ratchets and the appropriate sockets, often of both metric and fractions of inches. After the first few uses the container with all of the appropriate slots, becomes a jumble of misplaced sockets and often a complete unusable mess. How great would it be to have a simple oval ring which is open and the entire set of sockets and the wrench securely placed on one ring and displayed on a pegboard hook in the garage? They are easily located and used without the common problem of discovering the one you need (the ⅜″ socket) is the one that is missing.

The larger ring can easily be made with one arm threaded to screw into the end of the body which will have the appropriate threaded cylinder or coupling nut. With the arm removed, items such as sockets can easily be slid on the ring containing an entire set of sizes. Since it is threaded it can also be used to lock the right hook and left hook at a preferred 90 degree angle (see Drawings and Description sections) as the spring tension is released.

There are a number of even larger diameter connectors that could be effective for a variety of applications such as towing or moving objects where a rope or chain needs to be connected. But, here again, the existing rings don't normally have the strength to complete the task so other types of connectors must be found. The reality is, the uses would be greatly expanded should a product such as the Oval Spring Locking Ring were available.

### SUMMARY OF THE INVENTION

In accordance with the present invention, there is provided . . . an oval spring tension ring with left and right hooks at the opening on the top mid-section. It can contain one or more items or provide a connection between two points. Entry and exit is achieved by slipping items over the hooks. Locking and unlocking is provided by squeezing the oval ends. The right and left hooks slide by one another and, upon release of the pressure, engage the backs locking them securely on the ring.

It would be advantageous to provide a securing ring for multiple objects that was open for easy insertion of those objects.

It would be advantageous to provide a ring that is made of material with spring tension strength and memory.

It would also be advantageous to provide a ring that could safely contain objects from very small sizes (like fishing hooks and swivels) to large items like socket sets and measuring cups.

It would further be advantageous to provide a ring that has substantial strength when used to connect items at opposite ends of the oval, like fishing lines and hooks to lures.

It would also be advantageous to provide a containing ring that can be securely closed instantly, with very little effort.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a side view of an open oval spring locking ring in its relaxed (open) position;

FIG. 2 is a side view of a closed (locked) position;

FIG. 3 is a front view of an open oval locking ring;

FIG. 4 is a top view of an open oval locking ring;

FIG. 5 is a side view of an open oval spring locking ring with swivel attached;

FIG. 6 is a 3 d view of a snap swivel attached to lure; and

FIG. 7 is an exploded view of a large oval locking ring with one arm threaded with coupling nut.

For purposes of clarity and brevity, like elements and components will bear the same designations and numbering throughout the Figures.

### DESCRIPTION OF THE PREFERRED EMBODIMENT

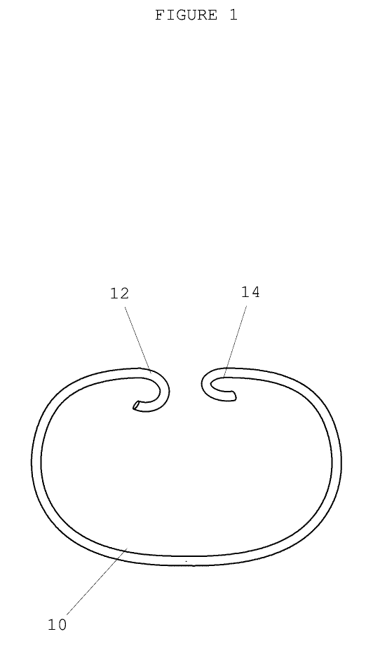

FIG. 1 is a side view of an open oval spring locking ring 16 in its relaxed (open) position. It is an oval body 10 made of suitable material such as spring steel or other strong material which has a memory (i.e. returns essentially to its original position when pressure is applied to change its shape or position and, and then released). This tendency is widely used for springs of all sizes and shapes from springs for vehicles (to absorb bumps and other shocks), to clocks, watches and other devices which measure pressure or other forces.

Because of these unique tendencies the range of potential uses is enormous. One such use is the oval spring locking ring 16. Two major uses (keys to key rings and pet tags to collars) involve a containing ring of one type or another which can simply store a number of objects in a secure position, or to connect two materials at opposite ends that will resist pressure against on another. Another example would be connecting fishing line to a lure 20 where the fish will resist the pressure to be reeled in and captured. Another example would be to connect a rope to a boat and tow a water skier.

Major uses are for containment including key rings, and pet tags, but the potential for many other containing functions is enormous, limited previously by the design and function of the containing rings and the difficulty in adding or removing objects.

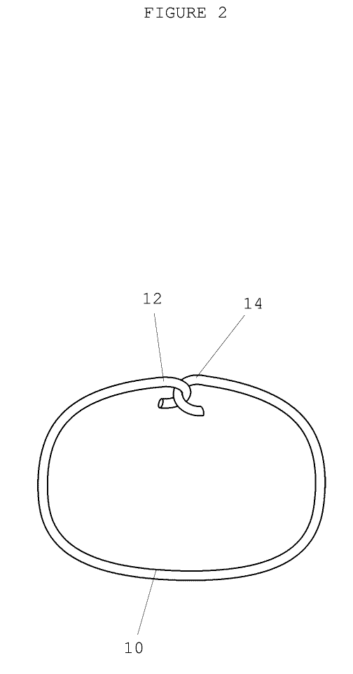

FIG. 2 is a side view of a closed (locked) position. This illustrates how the spring memory nature of the material can effectively lock itself in the closed position. When inward pressure is applied to opposite ends of the oval ring, the left hook 12 and right hook 14 are forced toward each other and, because of their curved nature and angle to one another (ideally 90 degrees), they will slide by one another. At that point the pressure can be released and the hooks will engage one another and slide to the rear center of each hook, connecting securely. The resulting spring tension will keep the hooks securely locked to one another regardless of external pressure. The more outward pressure applied to opposite ends of the oval will reinforce the locked position and is limited only to the tensile strength of the wire material itself. This usually far exceeds other commonly used containing connecting devices such as the split ring, which has no locking point.

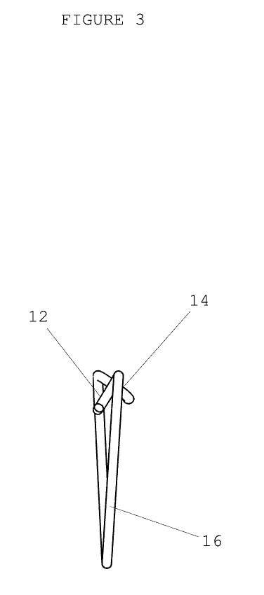

FIG. 3 is a front view of an oval locking ring 16. This helps to illustrate how the two sides of the oval body 10 are offset slightly from one another which allows the left hook 12 and right hook 14 to engage and slide by one another as inward pressure is applied to both ends of the oval body 10. Also of importance is the inclination of the two hooks which are angled down and in. This gives the most protection from outside interference with the ends of the right hook 14 and left hook 12. These ends are relatively short and the slight offset of the arms of the oval will protect even further

In larger rings (for containing multiple items) both hands can be used. This allows the two arms to be twisted slightly to facilitate the left hook 12 and right hook 14 passing one another as inward pressure is applied. When they pass each other, relieve the pressure and guide the hooks into the locking position. The spring tension of the wire ring will insure that they stay firmly locked together. An example of items that might be contained on the larger locking ring 16 is various sizes of measuring cups used in the kitchen. Often they will have a hole drilled at the end of the handle which facilitates their placement together on the ring. No more fishing through multiple drawers and boxes to find the properly sized measuring device. Another commonly used kitchen device is cookie cutters of different sizes and shapes. What often fills one or more drawers can be safely hung, on one hook.

The middle sizes of containment rings have several major uses. One is for key rings which usually have a hole in the body of the key to facilitate their containment on an oval spring locking ring 16. The common problem with mid-sized containment rings such as the often used split ring, is they are large enough to be difficult to pry open the end of the ring to start the insertion. They also must then slide around the ring one or more times, until they are seated on the ring itself. Since the end user seldom has a split ring pliers handy, it often results in using whatever is available (most commonly a pocket or kitchen knife). Following that, an attempt to pry it open with your fingers can lead to a broken finger nail or worse.

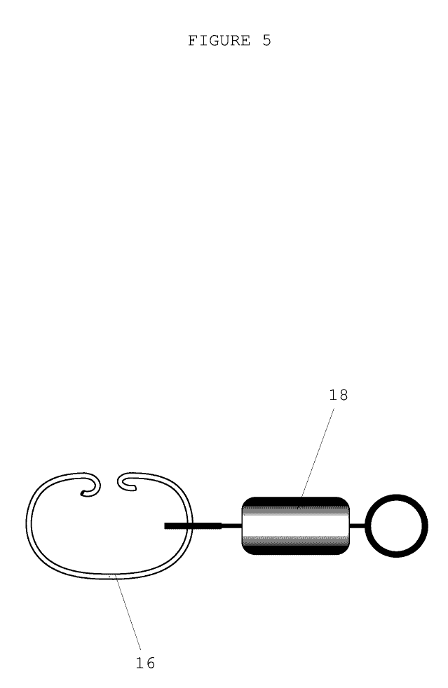

One of the biggest uses of split rings is for connecting fishing lures to fishing lines or hooks to the lure 20. This may require the use of a pinching tool (inventor is working on the proper design and patent application) due to the small sizes of locking rings involved. Due to the ease of attaching one or more things to the oval spring locking ring 16 it is a big savings in time and money to the lure 20 manufacturer and more fishing time for the angler. More on that in FIG. 5.

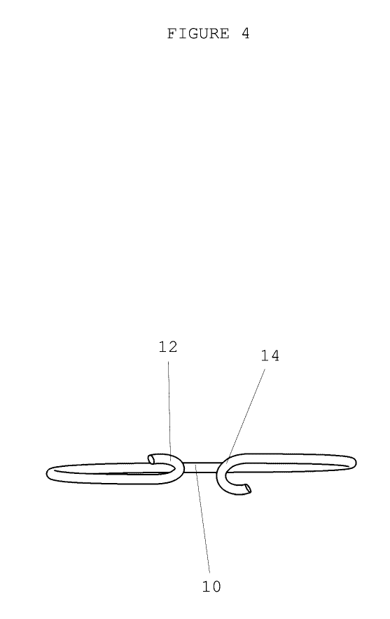

FIG. 4 is a top view of an open oval locking ring 16. This illustrates why the object are so simple to load and lock on the ring.

FIG. 5 is a side view of an open oval spring locking ring 16 with a swivel 18 attached. One of the largest items sold in terms of numbers is “snap swivels”. Both spinning and bait casting sports use a large number in connecting lures to fishing lines, which also prevents line twist where a swivel 18 is required (if the lure 20 tends to rotate). However, about half of the fishing sports market is made up of anglers who mainly bait fish. Here the use of snaps and snap swivel 18 is equally important so virtually the entire sport fishing market uses many swivels or snaps, and together, as “snap swivels”.

This locking ring 16 has several unique advantages. One is that the angler can combine any size swivel 18 he prefers with any size locking ring 16 he chooses, without have to buy whatever the manufacture has assembled and made available in the sporting goods store or “on line” over the Internet.

Another is the ease of changing from one lure 20 to another by simply pinching the ends of the oval body 10 of the locking ring 16 and making the switch. Still another is that the locking ring 16 is much less bulky than a typical snap. This can be a big advantage as most fish are turned off by bulky attachments where the lure 20 is connected to the line. Also, many of the snaps on the market simply slide into a groove and have no locking connection, so the fish of a lifetime is often lost when the snap arm pulls out of the snap body before the test strength of the fishing line is reached.

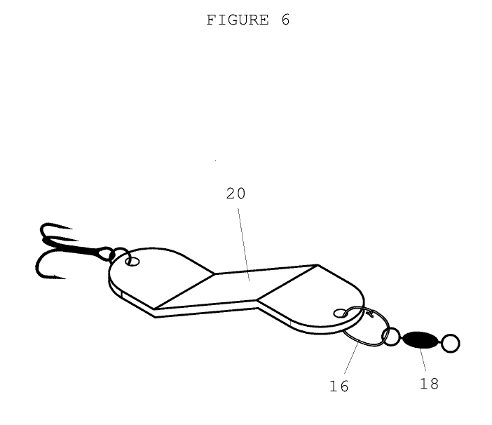

FIG. 6 is a 3 d view of a snap swivel 18 attached to the lure 20. This illustrates how the lure 20 attaches to fishing line. However many common lures such as plugs normally do not rotate in the water, but create vibration through the use of a lip or flat portion at the front of the plug body. In this case the swivel 18 is unnecessary and often the mere size of the snap swivel 18 is enough to cause a wary predator fish not to strike the lure 20. The angler can quickly remove the swivel 18 and use only the snap (ring) increasing their odds of success.

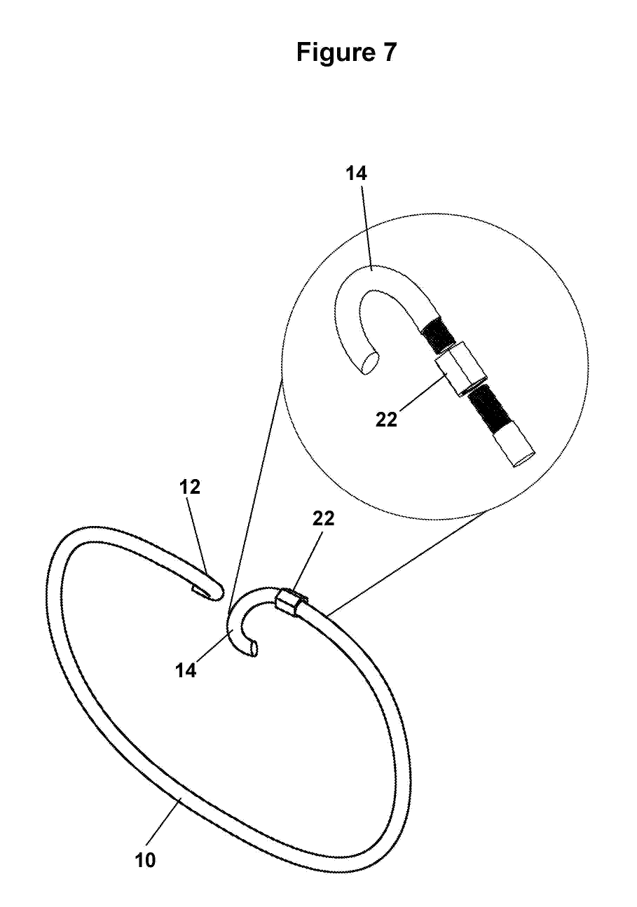

FIG. 7 illustrates a virtually untapped market, containing multiple similar purpose objects of different sizes. The reason this is not popular is there is no way currently available, to safely contain these objects. The standard split ring in large sizes is too difficult and in many cases (as with bulky objects) impossible. But the Oval Spring Locking ring 16 with coupling nut 22 can thread 24 onto one of the arms, with a similar thread 24 on the ring side. When the arm and coupling nut 22 are screwed off the threaded end of the ring, it provides an easy access for a multitude of products. This includes jewelry, cooking utensils, and wrenches, among others.

For simplicity of illustration, let's use the standard ratchet sets with different size connecting surfaces typically ¼″, ⅜″, and ½″. In the case of a ¼″ socket set that usually includes 8 to 10 items (from ¼″ up to 1″ in 1/16th inch increments) they all fit nicely on the locking ring 16 and safety contains the set in a matter of seconds. No more jumbled sockets and expensive cases with a separate slot for each size. The wrench itself can also be contained with the appropriate size with the addition of a hole at the end of the handle, something the socket set manufacturers will be glad to do, since it eliminates one the big problems (that of display and containment) along with reducing their costs.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An oval spring locking ring for containing or connecting one or more objects securely, comprising:
means for providing spring tension;
means for locking and opening the ring; and
means for engaging the left hook.

2. The oval spring locking ring in accordance with claim 1, wherein said means for providing spring tension comprises an opposite end resistance oval body.

3. The oval spring locking ring in accordance with claim 1, wherein said means for locking and opening the ring comprises an engaging the right hook left hook.

4. The oval spring locking ring in accordance with claim 1, wherein said means for engaging the left hook comprises a right hook.

5. An oval spring locking ring for containing or connecting one or more objects securely, comprising:
an opposite end resistance oval body, for providing spring tension;
an engaging the right hook left hook, for locking and opening the ring; and
a right hook, for engaging the left hook.

6. The oval spring locking ring as recited in claim 5, further comprising:
a locking ring, for removing and reattaching one of the hooks to the oval body.

7. The oval spring locking ring as recited in claim 5, further comprising:
a swivel, for providing terminal connection.

8. The oval spring locking ring as recited in claim 5, further comprising:
a coupling nut, for allowing bulky objects to easily access a large ring.

9. The oval spring locking ring as recited in claim 5, further comprising:
a thread, for connecting the right hook to the coupling nut and oval body.

10. The oval spring locking ring as recited in claim 6, further comprising:
a swivel, for providing terminal connection.

11. The oval spring locking ring as recited in claim 6, further comprising:
a coupling nut, for allowing bulky objects to easily access a large ring.

12. The oval spring locking ring as recited in claim 6, further comprising:
a thread, for connecting the right hook to the coupling nut and oval body.

13. The oval spring locking ring as recited in claim 7, further comprising:
a coupling nut, for allowing bulky objects to easily access a large ring.

14. The oval spring locking ring as recited in claim 7, further comprising:
a thread, for connecting the right hook to the coupling nut and oval body.

15. The oval spring locking ring as recited in claim 8, further comprising:
a thread, for connecting the right hook to the coupling nut and oval body.

16. The oval spring locking ring as recited in claim 10, further comprising:
a coupling nut, for allowing bulky objects to easily access a large ring.

17. The oval spring locking ring as recited in claim 10, further comprising:
a thread, for connecting the right hook to the coupling nut and oval body.

18. The oval spring locking ring as recited in claim 11, further comprising:
a thread, for connecting the right hook to the coupling nut and oval body.

19. The oval spring locking ring as recited in claim 13, further comprising:
a thread, for connecting the right hook to the coupling nut and oval body.

20. The oval spring locking ring as recited in claim 16, further comprising:
a thread, for connecting the right hook to the coupling nut and oval body.

21. An oval spring locking ring for containing or connecting one or more objects securely, comprising:
an opposite end resistance oval body, for providing spring tension;
an engaging the right hook left hook, for locking and opening the ring;
a right hook, for engaging the left hook;
a locking ring, for removing and reattaching one of the hooks to the oval body;
a swivel, for providing terminal connection;
a coupling nut, for allowing bulky objects to easily access a large ring; and
a thread, for connecting the right hook to the coupling nut and oval body.
